(19) United States
(12) Patent Application Publication
(10) Pub. No.: US 2024/0241657 A1
(43) Pub. Date: Jul. 18, 2024

(54) STORAGE DEVICE AND METHOD OF OPERATING THE SAME

(71) Applicant: SK hynix Inc., Gyeonggi-do (KR)

(72) Inventor: Sung Jin PARK, Gyeonggi-do (KR)

(21) Appl. No.: 18/348,347

(22) Filed: Jul. 7, 2023

(30) Foreign Application Priority Data
Jan. 12, 2023 (KR) 10-2023-0004824

(51) Int. Cl. G06F 3/06

(52) U.S. Cl. CPC G06F 3/064; G06F 3/0625; G06F 3/067

(57) ABSTRACT

A storage device according to the present disclosure includes a memory device including a plurality of memory blocks, and a memory controller configured to, when a boot data request is received from an external device, control the memory device to read a plurality of boot data items from memory blocks included in a super block based on boot address information indicating the super block in which the plurality of boot data items are stored, and provide the plurality of boot data items to the external device.

### CROSS-REFERENCE TO RELATED APPLICATION

The present application claims priority under 35 U.S.C. § 119(a) to Korean patent application number 10-2023-0004824 filed on Jan. 12, 2023, the entire disclosure of which is incorporated by reference herein.

### BACKGROUND

### 1. Field of Invention

Various embodiments of the present disclosure relate to an electronic device, and more particularly, to a storage device and a method of operating the same.

### 2. Description of Related Art

A storage device is a device that stores data under control of a host such as a computer, a smart phone, or the like. The storage device includes a memory device for storing data therein and a memory controller for controlling the memory device. The memory device may be a volatile memory device or a nonvolatile memory device.

The storage device may store boot data used for booting of the host and provide the boot data to the host according to a request of the host. That is, a host boot time is affected by a time during which the storage device provides the boot data to the host. Improving read performance of the boot data is required for fast booting of the host.

### SUMMARY

Embodiments of the present disclosure are directed to a storage device and a method of operating the same capable of improving read performance of boot data.

According to an embodiment of the present disclosure, a storage device may include a memory device including a plurality of memory blocks, and a memory controller configured to, when a boot data request is received from an external device, control the memory device to read a plurality of boot data items from memory blocks included in a super block based on boot address information indicating the super block in which the plurality of boot data items are stored, and provide the plurality of boot data items to the external device.

According to an embodiment of the present disclosure, a method of operating a storage device may include receiving a boot data request from an external device, reading boot address information indicating a super block in which a plurality of boot data items are stored, among super blocks each including a plurality of memory blocks, reading, based on the boot address information, the plurality of boot data items distributed and stored in each of the plurality of memory blocks included in the super block, and providing the plurality of boot data items to the external device.

According to an embodiment of the present disclosure, a method of operating a storage device may include receiving a request for setting a high-speed boot mode from an external device, allocating a super block when boot data is stored in a random storage state, sequentially storing the boot data in successive pages of each of memory blocks included in the super block, and storing, in an allocated system block, boot address information indicating the super block.

According to an embodiment of the present disclosure, a storage device and a method of operating the same having improved read performance of boot data may be provided. Accordingly, a booting speed of the host may be improved.

### BRIEF DESCRIPTION OF THE DRAWINGS

FIG. 1 is a diagram illustrating a storage device according to an embodiment of the present disclosure.

FIG. 2 is a diagram for describing an operation of storing boot data of a memory controller according to an embodiment of the present disclosure.

FIG. 3 is a sequence diagram for describing a method of storing boot data according to an embodiment of the present disclosure.

FIG. 4 is a diagram illustrating a super block according to an embodiment of the present disclosure.

FIG. 5 is a diagram illustrating a system block according to an embodiment of the present disclosure.

FIG. 6 is a diagram for describing an operation of reading boot data of a memory controller according to an embodiment of the present disclosure.

FIG. 7 is a sequence diagram for describing a method of reading boot data according to an embodiment of the present disclosure.

FIG. 8 is a diagram for describing a method of reading boot address information of a system block according to an embodiment of the present disclosure.

FIG. 9 is a diagram for describing a method of reading boot data of a super block according to an embodiment of the present disclosure.

FIG. 10 is a diagram for describing a method of operating a storage device according to an embodiment of the present disclosure.

FIG. 11 is a diagram for describing a method of operating a storage device according to an embodiment of the present disclosure.

### DETAILED DESCRIPTION

Specific structural or functional descriptions of embodiments according to the concept which are disclosed in the present specification are illustrated only to describe the embodiments according to the concept of the present disclosure. The embodiments according to the concept of the present disclosure may be carried out in various forms and should not be construed as being limited to the embodiments described in the present specification.

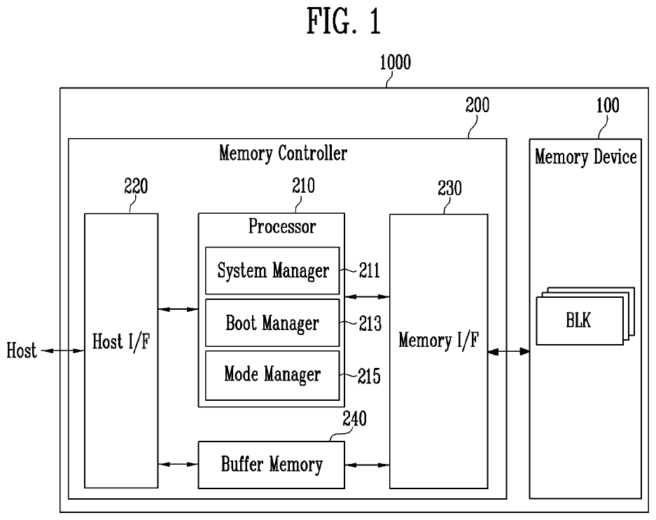

FIG. 1 is a diagram illustrating a storage device 1000 according to an embodiment of the present disclosure.

Referring to FIG. 1, the storage device 1000 may store boot data. When a boot data request is received from a host, the storage device 1000 may provide the boot data in response to the boot data request.

The storage device 1000 may be used as an auxiliary storage device or a main storage device for the host. The host may be an external device of the storage device 1000. The storage device 1000 may be implemented in a form in which the storage device 1000 is positioned outside the host or embedded inside the host.

For example, the storage device 100 may be implemented as one of a storage device of a type of a solid state disk (SSD), a multi-media card (MMC), an embedded MMC (eMMC), a reduced-size MMC (RS-MMC), and a micro-MMC, a storage device of a type of a secure digital (SD), a mini-SD, and a micro-SD, a universal serial bus (USB) storage device, a universal flash storage (UFS) device, a storage device of a personal computer memory card international association (PCMCIA) type, a storage device of a peripheral component interconnection (PCI) type, a storage device of a PCI express (PCI-E) type, a network attached storage (NAS), and a wireless network storage device. The host may be implemented as one of a desktop computer, a laptop computer, a mobile phone, a smart phone, a game machine, a television (TV), a tablet computer, or a wearable device. Here, the listed examples are only examples, the storage device 1000 is not limited thereto, the storage device 1000 may be implemented with various electronic devices that store data, and the host may be implemented with various electronic devices that use the data of the storage device 1000.

The storage device 1000 may include a memory device 100 and a memory controller 200. Here, the number of memory devices 100 may be plural. The memory device 100 and the memory controller 200 may communicate with each other through channels.

The memory device 100 may store data. Here, the data may include boot data. The boot data may be data used for booting which drives an operating system (OS). For example, the boot data may include commands configuring the OS. Boot indicates startup of the host. The OS may be, for example, Linux, Unix, Windows, Mac OS, Android, or the like.

In an embodiment, the memory device 100 may be implemented with various types of semiconductor memory devices. For example, the memory device 100 may be implemented as one of a NAND flash memory, a vertical NAND flash memory, a NOR flash memory, and the like.

The memory device 100 may include a plurality of memory blocks BLK. One memory block BLK may include a plurality of pages. One page may include a plurality of memory cells. The memory cell may store data of a bit unit. Here, a page may include memory cells of a unit in which a program operation of storing data or a read operation of reading stored data is performed. The memory block BLK may include memory cells of a unit in which an erase operation in which data is erased is performed. The boot data may be divided into a plurality of boot data items (or a plurality of boot data pieces) in a size unit of a page according to a size thereof. Each of the plurality of boot data items may be stored in one page.

The memory controller 200 may include a processor 210, a host interface (I/F) 220, a memory interface 230 and a buffer memory 240.

In an embodiment, the processor 210 may include a system manager 211, a boot manager 213, and a mode manager 215. The system manager 211 may allocate and manage a system block among the memory blocks BLK. The boot manager 213 may allocate and manage a memory block storing the boot data among the memory blocks BLK. When a request for setting a high-speed boot mode or a normal boot mode is received, the mode manager 215 may change a storage state of the plurality of boot data items to a sequential storage state or a random storage state.

The host interface 220 may receive data from the host. For example, the host interface 220 may receive various requests from the host. The request received from the host may include a boot data request instructing an output of the boot data, a storage mode change request instructing a change in a storage mode of the boot data, a write request instructing storage of data, a read request instructing an output of stored data, an erase request instructing deletion of stored data, and the like. Further, the host interface 220 may transmit, to the host, data corresponding to the request of the host.

The memory interface 230 may transmit or receive data to or from the memory device 100. For example, the memory interface 230 may exchange a command, an address, data, and the like with the memory device 100.

The buffer memory 240 may temporarily store data. For example, the data stored in the buffer memory 240 may include at least one of data received from the host or the memory device 100 and data processed by the processor 210. For example, the buffer memory 240 may store a command or address mapping information.

According to an embodiment of the present disclosure, the storage device 1000 and a method of operating the same having improved read performance of boot data may be provided. Accordingly, a booting speed of the host may be improved. Hereinafter, an embodiment of the present disclosure is described more specifically with reference to the accompanying drawings.

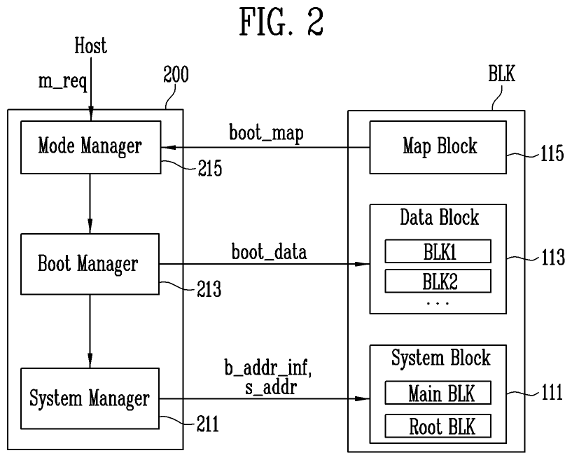

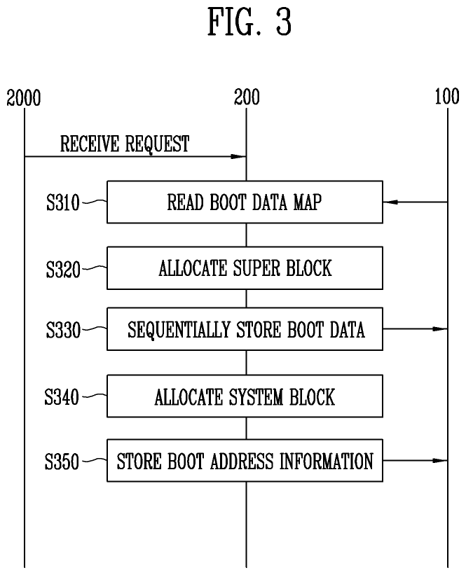

FIG. 2 is a diagram for describing an operation of storing boot data of the memory controller 200 according to an embodiment of the present disclosure. FIG. 3 is a sequence diagram for describing a method of storing boot data according to an embodiment of the present disclosure.

Referring to FIG. 2, the plurality of memory blocks BLK may include a system block 111 and a data block 113. The system block 111 may store system data for an operation of the memory device 100. The data block 113 may store user data or boot data boot_data. In an embodiment, the plurality of memory blocks BLK may further include a map block 115. The map block 115 may store a boot data map boot_map.

Referring to FIGS. 2 and 3, the mode manager 215 may receive a request m_req for setting a high-speed boot mode from the host 2000. The request m_req for setting the high-speed boot mode may instruct the memory controller 200 to change a storage state of the boot data boot_data to the sequential storage state. Further, the mode manager 215 may receive a request for setting the normal boot mode from the host 2000. The request for setting the normal boot mode may instruct the memory controller 200 to change the storage state of the boot data boot_data to the random storage state. As described above, according to the request of the host 2000, the storage state of the boot data boot_data may be changed to one of the random storage state and the sequential storage state. Here, the random storage state indicates a state in which the boot data is distributed and stored in a randomly selected memory block among the plurality of memory blocks BLK. The sequential storage state indicates a state in which the boot data is sequentially stored in memory blocks included in a super block among the plurality of memory blocks BLK.

When the request m_req for setting the high-speed boot mode is received, the mode manager 215 may read the boot data map boot_map stored in the map block 115 (operation S310). The boot data map boot_map may include information indicating whether a state in which the plurality of boot data items boot_data are stored in the data block 113 is the random storage state or the sequential storage state. In this case, the mode manager 215 may determine the storage state of the boot data boot_data through the boot data map boot_map. The boot data map boot_map may be modified and implemented as being stored in the buffer memory 240 of the memory controller 200. In this case, the mode manager 215 may read the boot data map boot_map from the buffer memory 240.

When the request m_req for setting the high-speed boot mode and a current storage state of the boot data boot_data is the random storage state, the boot manager 213 may allocate the super block including the memory blocks of the data block 113 (operation S320). The super block may include free blocks included in different memory devices so that interleaving is possible. A free block is a memory block of a state in which the boot data boot_data may be stored. The boot manager 213 may store super block allocation information in the map block 115 or the buffer memory 240. The super block allocation information may include addresses of memory blocks included in the super block and addresses of memory devices having the corresponding memory blocks.

The boot manager 213 may sequentially store the boot data boot_data in successive pages of each of the memory blocks included in the super block (operation S330). At this time, a garbage collection method may be used. For example, the boot manager 213 may control the memory device 100 to read the boot data boot_data stored in the random storage state. In addition, the memory controller 200 may control the memory device 100 to sequentially store the read boot data boot_data in successive pages of each of the memory blocks included in the super block.

When sequential storage of the boot data boot_data in the super block is completed, the system manager 211 may allocate the system block 111 (operation S340). Here, the system block 111 may include a root block Root BLK and a main block Main BLK. The root block Root BLK may be a system block at a level higher than that of the main block Main BLK. The root block Root BLK may have a fixed position, and the main block Main BLK may have a position which may be changed. For example, the system manager 211 does not allocate another memory block as the root block Root BLK after a first memory block among the plurality of memory blocks BLK is allocated as the root block Root BLK. After a second memory block among the plurality of memory blocks BLK is allocated as the main block Main BLK, the system manager 211 may allocate another memory block as the main block Main BLK. As described above, for a lifespan of the root block Root BLK having a fixed position, writing on the root block Root BLK is required to be minimized, and writing on the main block Main BLK is not limited.

The system manager 211 may store boot address information b_addr_inf in the main block Main BLK of the system block 111 (operation S350). The boot address information b_addr_inf may indicate an area in which the boot data is sequentially stored. In an embodiment, the boot address information b_addr_inf may include an address of a super block, an address of a start page where storage of the plurality of boot data items in one memory block starts, and a size of the boot data.

In an embodiment, the system manager 211 may control the memory device 100 to store boot address information b_addr_inf in a meta area within a page among a plurality of pages included in the main block Main BLK. Here, a page may include a data area and the meta area. The meta area may be an area where meta data is stored, and the data area may be an area where the boot data is stored. The meta area may have a storage space less than that of the data area. For example, the data area may be a storage area of 16 kilobytes and the meta area may have a storage space of 16 bytes. In an embodiment, the system manager 211 may control the memory device 100 to store the boot address information b_addr_inf in a meta area within the uppermost page among the plurality of pages included in the main block Main BLK. Here, the uppermost page may be accessed with the highest priority.

The system manager 211 may store an address s_addr of the main block Main BLK, in which the boot address information b_addr_inf is stored, in the root block Root BLK. For example, the system manager 211 may control the memory device 100 to store the address s_addr of the main block Main BLK in a page next to a last programmed page among a plurality of pages included in the root block Root BLK. Hereinafter, the disclosure is described in terms of a block in which data is stored.

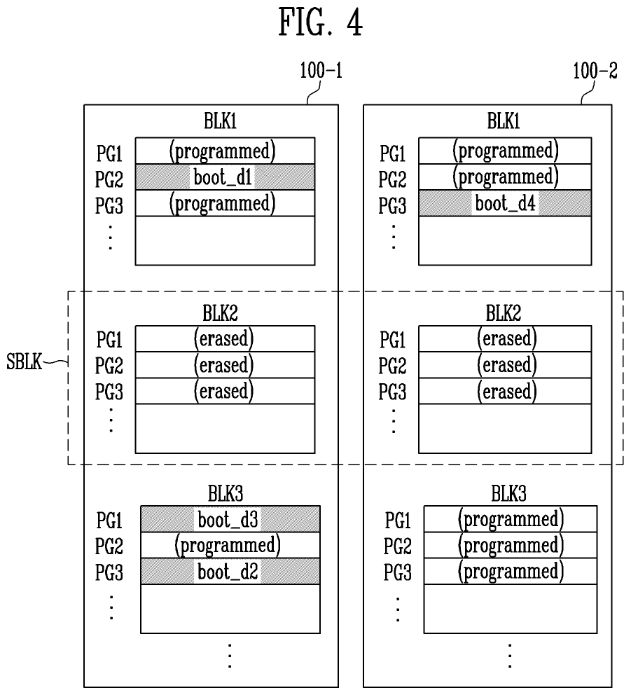

FIG. 4 is a diagram illustrating a super block according to an embodiment of the present disclosure.

Referring to FIGS. 2 and 4, each of a first memory device 100-1 and a second memory device 100-2 may include a first memory block BLK1 to a third memory block BLK3.

Each of the first memory block BLK1 to the third memory block BLK3 may include a first page PG1 to a third page PG3. Each of the pages PG1 to PG3 may have one of an erased state and a programmed state. The programmed state indicates a state in which data is currently stored, and the erased state may be a state in which data is not currently stored. Here, the free block indicates that all pages included in the corresponding memory block are in the erased state. Here, the second memory block BLK2 may be the free block. Data may be boot data boot_d1 to boot_d4 or user data. The plurality of boot data items boot_d1 to boot_d4 may be data for driving one OS. The first memory block BLK1 to the third memory block BLK3 may be memory blocks included in the data block 113 described above with reference to FIG. 2. The number of memory devices and pages is arbitrarily set for illustrative purposes, and the number thereof may be variously modified and implemented.

In an embodiment, as shown in FIG. 4, the plurality of boot data items boot_d1 to boot_d4 may be stored in the random storage state. The random storage state may be a state in which the plurality of boot data items boot_d1 to boot_d4 are randomly distributed and stored, and may indicate that the plurality of boot data items boot_d1 to boot_d4 are not sequentially stored in successive pages within the super block. Here, the boot data map for identifying the random storage state is stored in the first memory device 100-1.

When the request for setting the high-speed boot mode is received from the host 2000, the mode manager 215 of the memory controller 200 may read the boot data map stored in the first memory device 100-1, and determine a storage state of the plurality of boot data items boot_d1 to boot_d4 as the random storage state using the read boot data map.

The boot manager 213 of the memory controller 200 may allocate a super block SBLK. For example, the memory controller 200 may allocate the super block SBLK including the second memory block BLK2 which is the free block of the first memory device 100-1 and the second memory block BLK2 which is the free block of the second memory device 100-2 among the plurality of memory blocks BLK1 to BLK3 included in the plurality of memory devices 100-1 and 100-2.

The boot manager 213 may control the plurality of memory devices 100-1 and 100-2 to read the plurality of boot data items boot_d1 to boot_d4 stored in the random storage state. For example, the boot manager 213 may transmit a read command and an address to the plurality of memory devices 100-1 and 100-2 to read stored boot data among the plurality of boot data items boot_d1 to boot_d4. In this case, the buffer memory 240 of the memory controller 200 may receive and temporarily store the plurality of boot data items boot_d1 to boot_d4 from each of the plurality of memory devices 100-1 and 100-2.

The boot manager 213 may control the plurality of memory devices 100-1 and 100-2 to sequentially store the boot data boot_d1 to boot_d4 in pages PG1 and PG2 of the plurality of memory blocks BLK2 included in the super block SBLK. For example, the boot manager 213 may transmit a program command, an address of the second memory block BLK2 and the first page PG1, and first boot data boot_d1 to the first memory device 100-1. The program command, the address of the second memory block BLK2 and the first page PG1, and second boot data boot_d2 may be transmitted to the second memory device 100-2, and the boot manager 213 may transmit the program command, an address of the second memory block BLK2 and the second page PG2, and third boot data boot_d3 to the first memory device 100-1, and may transmit the program command, the address of the second memory block BLK2 and the second page PG2, and fourth boot data boot_d4 to the second memory device 100-2. In this case, the first memory device 100-1 may store the first boot data boot_d1 and the third boot data boot_d3 in the second memory block BLK2 through a successive writing method. For example, the first memory device 100-1 may store the first boot data boot_d1 in the first page PG1 of the second memory block BLK2 and sequentially store the third boot data boot_d3 in the second page PG2 of the second memory block BLK2. Likewise, the second memory device 100-2 may store the second boot data boot_d2 and the fourth boot data boot_d4 in the second memory block BLK2 through a successive writing method.

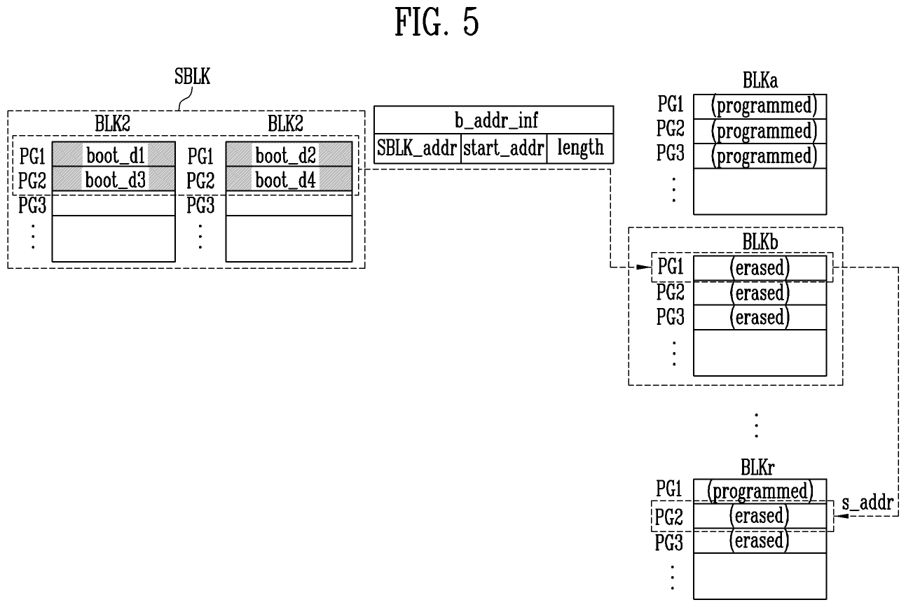

FIG. 5 is a diagram illustrating a system block according to an embodiment of the present disclosure.

Referring to FIGS. 2 and 5, the system manager 211 of the memory controller 200 may allocate as the system block 111 any of a plurality of memory blocks BLKa to BLKr. Here, a memory block BLKb is allocated as the main block Main BLK of the system block and a memory block BLKr is allocated as the root block Root BLK of the system block.

The system manager 211 may control the memory device including the memory block BLKb to store the boot address information b_addr_inf in a preset page of the memory block BLKb. For example, the system manager 211 may transmit a program command, an address of the preset page, and the boot address information b_addr_inf to the memory device including the memory block BLKb. For example, the preset page may be the first page PG1. In an embodiment, the boot address information b_addr_inf may be stored in the meta area of the data area and the meta area included in the page.

The boot address information b_addr_inf may include an address SBLK_addr of the super block SBLK storing the boot data boot_d1 to boot_d4, an address start_addr of a start page where storage of the boot data boot_d1 to boot_d4 starts, and a size length of the boot data boot_d1 to boot_d4. The size length of the boot data boot_d1 to boot_d4 may indicate the number of pages in which the boot data boot_d1 to boot_d4 are to be stored. For example, when the first page PG1 is the start page, the address of the start page may be ‘1’. When the number of boot data boot_d1 to boot_d4 is four and the number of memory blocks included in the super block SBLK is two, the size length may be ‘2’.

The system manager 211 may control the memory device including the root block BLKr to store the address s_addr of the memory block BLKb allocated as the main block in the root block BLKr. For example, the memory controller 200 may store the address s_addr of the main block in a second page PG2, which is a next page of the last programmed first page PG1, in the root block BLKr.

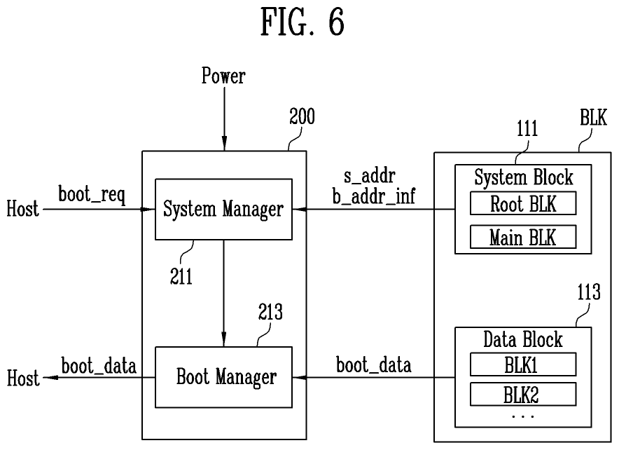

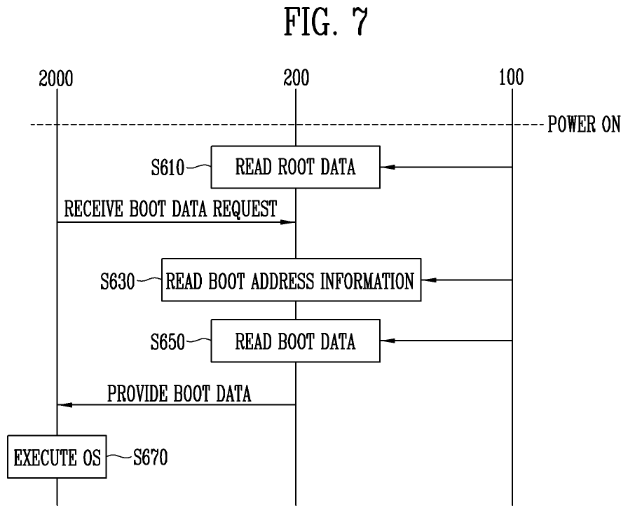

FIG. 6 is a diagram for describing an operation of reading boot data of the memory controller 200 according to an embodiment of the present disclosure. FIG. 7 is a sequence diagram for describing a method of reading boot data according to an embodiment of the present disclosure.

Referring to FIGS. 6 and 7, the memory controller 200 may include the system manager 211 and the boot manager 213.

When the memory controller 200 or the storage device 1000 is changed from a power off state to a power on state, the system manager 211 may control the memory device 100 including the root block Root BLK to read root data stored in the root block Root BLK of the system block 111 (operation S610). Here, the root data may include the address s_addr of the main block Main BLK storing the boot address information b_addr_inf. In an embodiment, the system manager 211 may read the root data stored in the last programmed page of the root block Root BLK. Thereafter, the system manager 211 may wait until a boot data request boot_req is received.

When the boot data request boot_req is received from the host 2000, the system manager 211 may control the memory device 100 including the main block Main BLK to read the boot address information b_addr_inf stored in the main block Main BLK of the system block 111 (operation S630). Here, the boot address information b_addr_inf may include an address of the super block, an address of a start page where storage of the plurality of boot data items boot_data starts, and a size of the boot data boot_data.

In an embodiment, the system manager 211 may control the memory device 100 to read the boot address information b_addr_inf from a preset page of the main block Main BLK. For example, the system manager 211 may transmit a read command and the address s_addr of the main block Main BLK to the memory device 100. As a result of a read operation according to the read command, the system manager 211 may receive the boot address information b_addr_inf output from the memory device 100. The address s_addr of the main block Main BLK may include a block address. In an embodiment, the address s_addr of the main block Main BLK may not include a page address. The preset page may be a page among the plurality of pages included in the main block Main BLK. In an embodiment, the boot address information b_addr_inf may be stored in a meta area of the preset page and read from the meta area of the preset page.

When the boot address information b_addr_inf is received, the boot manager 213 may control the memory device 100 having the memory block included in the super block to read the boot data boot_data stored in the super block (operation S650).

In an embodiment, the boot manager 213 may identify addresses of the memory device, the memory block, and the page in which the boot data boot_data is stored using the boot address information b_addr_inf. For example, the address of the super block may indicate the addresses of the memory device and the memory block. The address of the start page and the size of the boot data boot_data may indicate a page in which the boot data boot_data is stored. The boot manager 213 may transmit the read command, the address of the memory block included in the super block, and the address of the page to the memory device 100 having the memory block included in the super block. The buffer memory 240 may receive and temporarily store the boot data boot_data output as a result of the read operation of the memory device 100. The boot manager 213 may transmit the boot data boot_data received from the memory device 100 to the host 2000.

When reception of the plurality of boot data items boot_data is completed, the host 2000 may execute the OS using the plurality of boot data items boot_data (operation S670).

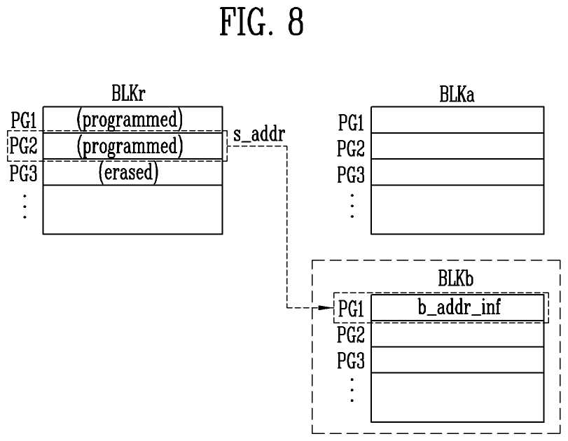

FIG. 8 is a diagram for describing a method of reading boot address information of a system block according to an embodiment of the present disclosure.

Referring to FIGS. 6 and 8, when the storage device 1000 is changed from the power off state to the power on state, the system manager 211 may control the memory device including the root block BLKr to read the root data from the second page PG2 which is the last programmed page of the root block BLKr. The root data may include the address s_addr of the main block Main BLK storing the boot address information b_addr_inf.

Thereafter, when receiving the boot data request boot_req from the host 2000, the system manager 211 may control the memory device including the main block BLKb to read a preset area of the main block BLKb indicated by the address s_addr of the main block Main BLK among the memory blocks BLKa and BLKb. The boot address information b_addr_inf may be stored in the preset area. For example, the preset area may be the meta area of the first page PG1.

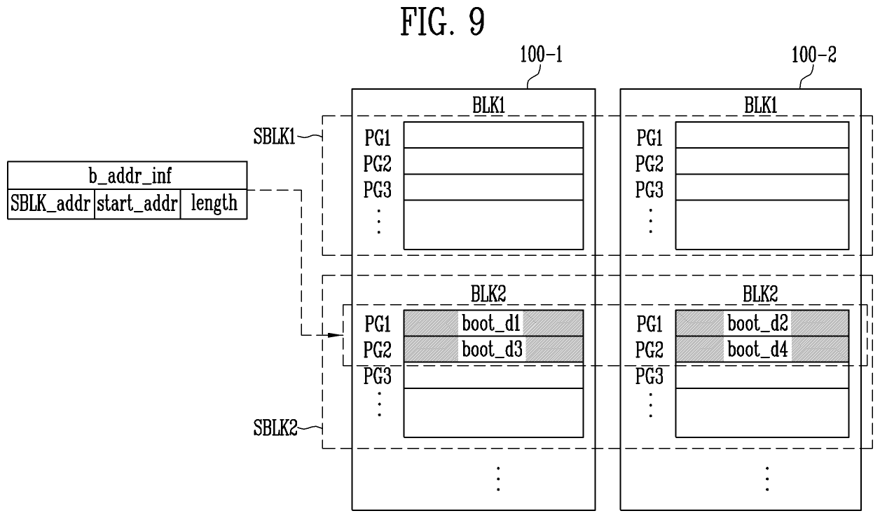

FIG. 9 is a diagram for describing a method of reading boot data of a super block according to an embodiment of the present disclosure.

Referring to FIGS. 6 and 9, the boot manager 213 may identify a second super block SBLK2 among a plurality of super blocks SBLK1 and SBLK2, by using the boot address information b_addr_inf read from the main block. The second super block SBLK2 is a super block in which the plurality of boot data items boot_d1 to boot_d4 are stored.

For example, the boot manager 213 may identify the second super block SBLK2 corresponding to the address SBLK_addr included in the boot address information b_addr_inf. The address start_addr of the start page included in the boot address information b_addr_inf indicates the first page PG1 and the size length indicates ‘4’. In this case, the boot manager 213 may identify that the boot data boot_d1 to boot_d4 are stored in the first page PG1 to the second page PG2 of the second memory block BLK2 of the first memory device 100-1 and the first page PG1 to the second page PG2 of the second memory block BLK2 of the second memory device 100-2, according to the address start_addr of the start page and the size length.

The boot manager 213 may transmit the read command and an address of the first page PG1 to the second page PG2 to the first memory device 100-1 and the second memory device 100-2 so that each of the first memory device 100-1 and the second memory device 100-2 simultaneously performs the read operation. The buffer memory 240 may receive the boot data boot_d1 to boot_d4 output from each of the first memory device 100-1 and the second memory device 100-2. The boot manager 213 may transmit the received boot data boot_d1 to boot_d4 to the host 2000.

In an embodiment, a data size of the boot address information b_addr_inf may be less than a data size of logical-physical address mapping information. The logical-physical address mapping information may store a mapping relationship between an address of a page and data stored in the corresponding page. The boot manager 213 may more quickly identify an address of an area where the boot data boot_d1 to boot_d4 are stored by reading the boot address information b_addr_inf having the data size less than that of the logical-physical address mapping information. In addition, the boot data boot_d1 to boot_d4 may be evenly distributed and stored in the plurality of memory devices 100-1 and 100-2 within a range of the super block according to the high-speed boot mode, and may be stored in a sequential page unit in one memory block. Since the read operation for the boot data boot_d1 to boot_d4 may be simultaneously performed, a speed of the read operation for the boot data boot_d1 to boot_d4 may be improved and a booting speed of the host 2000 may be improved.

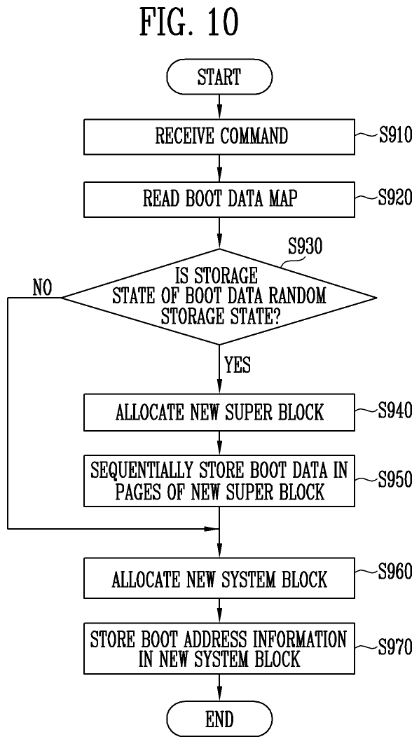

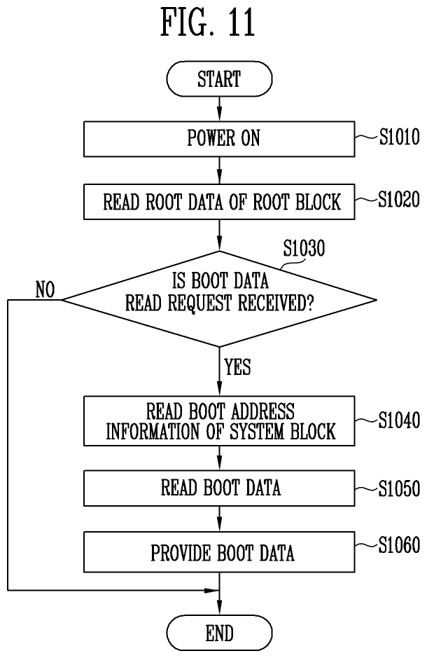

FIG. 10 is a diagram for describing a method of operating a storage device according to an embodiment of the present disclosure. An operation illustrated in FIG. 10 is performed while the storage device is in a power on state before performing an operation illustrated in FIG. 11, and the plurality of boot data items are stored in distributed pages and memory blocks included in one super block are in a free block state before the boot data request is received.

Referring to FIG. 10, a command for setting the high-speed boot mode may be received from the external device (operation S910). Here, the external device may be the host 2000.

In addition, the boot data map may be read (operation S920). Here, the boot data map may be stored in the memory device 100 or the buffer memory inside the memory controller 200.

In addition, it may be determined whether the storage state of the plurality of boot data items is the random storage state (operation S930). According to whether positions of the plurality of boot data items are distributed or contiguous through the boot data map, it may be determined whether the storage state is the random storage state.

In addition, when it is determined that the storage state is the random storage state (‘YES’ in the operation S930), a new super block may be allocated (operation S940). The new super block may include memory blocks which are free blocks of different memory devices.

In addition, the plurality of boot data items stored in the random storage state may be sequentially stored in successive pages of each of the memory blocks included in the new super block (operation S950).

In addition, after the plurality of boot data items are sequentially stored, a new system block may be allocated (operation S960). In addition, boot address information indicating the new super block may be stored in a preset page area of the new system block (operation S970).

When it is determined that the storage state is not the random storage state (‘NO’ in the operation S930), the operation of allocating the new super block (i.e., the operation S940) and the operation of sequentially storing the boot data (i.e., the operation S950) may be omitted. This is because a lifespan of the memory block may be reduced when an operation of a garbage collection method is re-performed. According to the present disclosure, even in this case, a load applied to the memory block may be minimized. In this case, the new system block may be allocated (the operation S960). In addition, boot address information indicating the new super block may be stored in a preset page area of the new system block (the operation S970). Here, the preset page area may be a meta area of the first page among the plurality of pages. For example, the first page may be a zero-th page of the system block. This is to read the boot address information faster by searching only the zero-th page. In addition, this is because allocating the new system block is required to store the boot address information in the zero-th page due to a characteristic in which the program operation of storing data is performed in a page unit. When the boot address information is already stored in the first page, allocation and storage operations of the system block (i.e., the operations S960 and S970) may be omitted.

FIG. 11 is a diagram for describing a method of operating a storage device according to an embodiment of the present disclosure.

Referring to FIG. 11, when changed from the power off state to the power on state (operation S1010), the root data of the root block may be read (operation S1020). Specifically, the root data may include an address of a system block stored in the most recently programmed page of the root block. Here, the system block may be a memory block that stores the boot address information.

A boot data read request may be received from the external device. Here, the external device may be the host 2000. When the boot data read request is received (‘YES’ in operation S1030), the boot address information of the system block may be read (operation S1040). Here, the system block may be a memory block indicated by the address stored in the most recently programmed page of the root block.

The boot address information may indicate one super block in which the plurality of boot data items are stored among the super blocks. In an embodiment, the boot address information may include the address of one super block, the address of the page where storage of the plurality of boot data items starts, and the size of the boot data.

The boot address information may be stored in a page area of a system block corresponding to the address. In an embodiment, the page area may be a meta area of one page among the plurality of pages included in the system block.

Based on the boot address information, the plurality of boot data items may be read from one super block (operation S1050). That is, a plurality of memory devices configuring one super block may simultaneously perform the read operation in an interleaving method. The plurality of read boot data may be provided to the external device (operation S1060).

When the boot data read request is not received (‘NO’ in the operation S1030), the operation may be ended without provision of the boot data. That is, the storage device 1000 may wait without provision of the boot data until the boot data read request is received.

While the present disclosure has been shown and described with reference to certain embodiments thereof, it will be understood by those skilled in the art that various changes in form and details may be made therein without departing from the spirit and scope of the present disclosure as defined by the appended claims and their equivalents. Therefore, the scope of the present disclosure should not be limited to the above-described embodiments but should be determined by not only the appended claims but also the equivalents thereof.

In the above-described embodiments, all operations may be selectively performed or part of the operations may be omitted. In each embodiment, the operations may not be performed in accordance with the described order and may be rearranged. The embodiments disclosed in this specification and drawings are only examples to facilitate an understanding of the present disclosure, and the present disclosure is not limited thereto. That is, it should be apparent to those skilled in the art that various modifications can be made on the basis of the technological scope of the present disclosure.

Meanwhile, the embodiments of the present disclosure have been described in the drawings and specification. Although specific terminologies are used here, those are only to describe the embodiments of the present disclosure. Therefore, the present disclosure is not restricted to the above-described embodiments and many variations are possible within the spirit and scope of the present disclosure. It should be apparent to those skilled in the art that various modifications can be made on the basis of the technological scope of the present disclosure in addition to the embodiments disclosed herein and the following claims. Furthermore, the embodiments may be combined to form additional embodiments.

What is claimed is:

1. A storage device comprising:
a memory device including a plurality of memory blocks; and
a memory controller configured to:
when a boot data request is received from an external device, control the memory device to read a plurality of boot data items from memory blocks included in a super block, based on boot address information indicating the super block in which the plurality of boot data items are stored, and
provide the plurality of boot data items to the external device.

2. The storage device of claim 1, wherein the memory controller comprises a boot manager configured to:
identify the memory blocks included in the super block corresponding to the boot address information, and
control the memory device to read, from each of the memory blocks included in the super block, the plurality of boot data items stored through a successive writing method.

3. The storage device of claim 2, wherein the boot address information includes an address of the super block, an address of a start page where storage of the plurality of boot data items starts, and a size of the plurality of boot data items.

4. The storage device of claim 2, wherein the plurality of boot data items include:
a first boot data item stored in a first page of a first memory block among the memory blocks included in the super block,
a second boot data item stored in a second page which is a next page of the first page of the first memory block,
a third boot data item stored in a third page of a second memory block, and
a fourth boot data item stored in a fourth page which is a next page of the third page of the second memory block.

5. The storage device of claim 1, wherein the plurality of memory blocks includes at least one of a main block for storing the boot address information, a root block for storing an address of the main block, and a data block for storing user data or boot data.

6. The storage device of claim 5, wherein the memory controller comprises a system manager configured to:
when the storage device is changed from a power-off state to a power-on state, read the address of the main block stored in a last programmed page among a plurality of pages included in the root block, and
read the boot address information stored in a preset area of the main block corresponding to the address.

7. The storage device of claim 6, wherein the preset area is a meta area of a first page among a plurality of pages included in the main block.

8. The storage device of claim 5, wherein the memory controller comprises:
a mode manager configured to read a boot data map indicating a storage state of the plurality of boot data items when a request for setting a high-speed boot mode is received from the external device; and
a boot manager configured to allocate, when a storage state of the plurality of boot data items is a random storage state, a new super block including a plurality of free blocks, and distribute and store the plurality of boot data items in each of the plurality of free blocks included in the new super block.

9. The storage device of claim 8, wherein the memory controller further comprises a system manager configured to:
store new boot address information indicating the new super block in a meta area of one page among a plurality of pages included in the main block, and
store an address of the main block storing the new boot address information, in a page next to a last programmed page among a plurality of pages included in the root block.

10. A method of operating a storage device, the method comprising:
receiving a boot data request from an external device;
reading boot address information indicating a super block in which a plurality of boot data items are stored, among super blocks each including a plurality of memory blocks;
reading, based on the boot address information, the plurality of boot data items distributed and stored in each of the plurality of memory blocks included in the super block; and
providing the plurality of boot data items to the external device.

11. The method of claim 10, further comprising:
reading, before the boot data request is received, an address of a main block, stored in a last programmed page of a root block, when the storage device is changed from a power off state to a power on state; and
reading, after the boot data request is received, the boot address information stored in the main block corresponding to the address.

12. The method of claim 10, further comprising:
reading a boot data map indicating whether a storage state of the plurality of boot data items is a random storage state when a command for setting a high-speed boot mode is received;
allocating, when the storage state is the random storage state, a new super block including a plurality of free blocks; and
distributing and storing the plurality of boot data items in successive pages of each of the plurality of free blocks included in the new super block.

13. The method of claim 12, wherein distributing and storing the plurality of boot data items comprises:
storing a first boot data item among the plurality of boot data items in a first page of a first free block included in the super block, and storing a second boot data item among the plurality of boot data items in a second page subsequent to the first page of the first free block; and
storing a third boot data item among the plurality of boot data items in a third page of a second free block included in the super block, and storing a fourth boot data item among the plurality of boot data items in a fourth page subsequent to the third page of the second free block.

14. The method of claim 12, further comprising:
storing new boot address information indicating the new super block, in a main block among the plurality of memory blocks, after the plurality of boot data items are stored; and
storing an address of the main block in a page next to a last programmed page among a plurality of pages included in a root block among the plurality of memory blocks.

15. The method of claim 10, wherein the boot address information includes an address of the super block, an address of a page where storage of the plurality of boot data items starts, and a size of the plurality of boot data items.

16. A method of operating a storage device, the method comprising:
receiving a request for setting a high-speed boot mode from an external device;
allocating a super block when boot data is stored in a random storage state;
sequentially storing the boot data in successive pages of each of memory blocks included in the super block; and
storing, in an allocated system block, boot address information indicating the super block.

17. The method of claim 16, further comprising:
reading, when powered on, root data related to the boot address information stored in the allocated system block;
receiving a boot data request from the external device;
reading the boot address information from the allocated system block;
reading, based on the boot address information, the boot data distributed and stored in the super block; and
providing the read boot data to the external device.
